(19) United States
(12) Patent Application Publication
(10) Pub. No.: US 2009/0254427 A1
(43) Pub. Date: Oct. 8, 2009

(54) Internet directory and method

(76) Inventor: Thomas Garrison, Bellingham, WA (US)

Correspondence Address: Thomas M. Garrison, P.O. Box 28261, Bellingham, WA, 98228, US

(21) Appl. No.: 12/099,754

(22) Filed: Apr. 8, 2008

(51) Int. Cl. G06Q 30/00; G06F 7/10; G06F 17/30

(52) U.S. Cl. 705/14; 707/4; 707/E17.014

(57) ABSTRACT

Systems and methods are provided for identifying information about an entity through Web site software. The entity may be a business or service. Information about the entity can be determined by processing attributes known about the entity, such as a name, service or other keywords. For example, user comes to the site, selects their desired state, city, and category. At that point the user clicks the “Search” button and is directed to a second page where they find a list of listing results. The user selects the desired listing and is then directed to a third page. This page is a full-page advertisement for the one business selected from the search results. A database of Web sites associated with categories is created by businesses adding their own business to the database.

### FIELD OF THE INVENTION

The present invention relates to directory services provided through a website, in particular an Internet directory specifically aimed at local searching as opposed to Nation wide listings for businesses only.

The Internet is rapidly becoming a resource to which people turn for a number of services. In particular, a number of business directory services have been established on the Internet, replacing the traditional business directories distributed by telephone companies. Such business directories allow a user to look up a particular business using the Internet but are difficult to find and/or use.

In addition, other sites on the Internet provide map services for a variety of purposes. Some sites can simply store a large number of maps that the user can view. Other sites for a particular business or operation will often include a map showing their location. Some of these may provide directions to the location of the business in response to a user input.

### BACKGROUND OF THE INVENTION

An Internet directory specifically aimed at local searching as opposed to Nation wide listings for businesses only using a full-page advertisement, map, images of the business at a very low monthly rate. Additionally, each listing is created and managed by the business. Each business listed may access their account 24/7.

Every state and city in the U.S. is included in the database.

A user comes to the site (www.CityDirectoryOnLine.com/), selects their desired state, city, and category. The next page provides listings of every business from the search performed. Free listings are text only and provide the business name, address and contact information. Paid listings results include the business name, address, and contact information and are hyper linked to the full-page dedicated to that one business.

Each company that has paid for a listing will have two packages from which to choose upon registering.
The first package, “Basic Package”, will allow the business to have up to 3 pictures, text link listings in up to 5 related categories, business name, address, phone, a form to contact the business via E-mail , and a small map that will indicate the area to find the business. The map can be enlarged and moved in order to see the surrounding area.
The second package, “Premium Package”, will have all of the above plus: up to 15 related category listings; a “Featured Listing” in the every page on right column; The premium listings will rotate each time the page is refreshed or the user moves to another page so that the list is always in a random order allowing every listing the same opportunities.

The user will also have the choice to search the entire database to include nationwide listings. But, the site will be directing the user to search for “local” listings.

There will also be a “free” listing that will allow the business to add a text listing in one related category to include the name, address and phone of the company.

What's different from the current on line directories?
Businesses who pay for a listing at City Directory On Line will have 24 hour access to their listing in order to update pictures, information or whatever necessary. Each business will have the choice of a 6 months or 12 months fee.
Any business in any city can make their secure payment, create an account with their own log in and password, have their own single-page Web site and know nothing about Web design or coding.
The pricing—$8.00 per month (making either 6 months or 12 months payment) for the basic package. $12.00 per month for the premium package. Our most expensive annual package is less than the average monthly local directory advertisement.
Easy to use site.
No intrusive advertising.
LOCAL listing results unless you purposely choose to search Nationwide or an entire city or state.
No personal listings—only businesses.

### PRIOR ART

Publication No.: US 2006/0218043 A1

U.S. Pat. No. 5,944,769

U.S. Pat. No. 6,148,289

U.S. Pat. No. 6,189,003 B1

U.S. Pat. No. 6,208,998 B1

U.S. Pat. No. 6,523,012 B1

U.S. Pat. No. 6,788,769 B1

U.S. Pat. No. 7,148,743 B2

U.S. Pat. No. 6,535,888 B1

1) U.S. Pat. No. 5,944,769

Description:

The present invention provides a network accessible service which integrates both a business directory and a map database. A user can search the business directory in a variety of methods, including using aspects of the map database (i.e., a radius) to quantify the search. The user can then obtain directions from a specified user location to a selected search result. All of this is conveniently accomplished through a single website access.

My invention overcomes the deficiencies of the previous invention because City Directory On Line is not a network. Instead, the database is created by businesses adding their own listing directly into the site—not listings derived from an already existing source.

Because it's a “local” directory, there are 2 methods of searching:
select a state, then a city, then a category, then a business from the results.
search “site wide” using the Nationwide search box located centrally on the site

Each paid listing has its own full-page in the directory for that one business. That business creates a user name and password in order to access their paid account listing.

Each paid listing has up to 15 related category listings and may also be found in the “Featured Listings” (depending on the specific package purchased) that appear in every page. When a selection is made from the search results, one business is revealed with the images and information supplied directly from the business. It is up to the business to upload images and content. The business may access their one page 24 hours a day/365 days per year.

A small map is found in the businesses single page in order that a user will find the business easily.

2) U.S. Pat. No. 6,148,289

Description:

A method and search engine for classifying a source publishing a document on a portion of a network, includes steps electronically receiving a document, based on the document, determining a source which published the document, and assigning a code to the document based on whether data associated with the document published by the source matches with data contained in a database. An intelligent geographic- and business topic-specific resource discovery system facilitates local commerce on the World Wide Web and also reduces search time by accurately isolating information for end-users. Distinguishing and classifying business pages on the Web by business categories using Standard Industrial Classification (SIC) codes is achieved through an automatic iterative process.

My invention overcomes the deficiencies of the previous invention as my directory is not related nor a part of a network. City Directory does not include documents relating to any business found in our directory. City Directory is not a document-based search to find related businesses. City Directory does not use SIC codes to identify the business. City Directory also does not integrate with the “whois” database nor any “Yellow Pages” database.

Simply, City Directory is a stand-alone database in which a business may upload up to 3 images in a single page (in addition to the contact information and description of said business) that is related to (up to) 15 categories and is searched by related keywords or phrases or category. It is akin to a business having a single page Web site developed for that business.

3) U.S. Pat. No. 6,189,003 B1

Description:

A system and method to provide buyers with information that supports the selection of qualified vendors and service providers at the precise time they are prepared to make a purchase. To accomplish its function, the system includes three core elements: (1) a data retrieval system that makes it easy to ready and willing buyers to find and contact qualified businesses: (2) a proprietary electronic database with enhanced information regarding local businesses: (3) an electronic distribution network that employs live, enhanced directory assistance (EDA) operators via telephone as well as the World Wide Web, and simplifies the connections between motivated buyers and qualified sellers. Buyers are able to search the database of businesses to find the most qualified providers of goods/service that match their unique criteria. Sellers can use the service to better promote their offerings to a market that has moved beyond window shopping and that is ready to buy.

My invention overcomes the deficiencies of the previous invention as my directory uses only the businesses that have added their information (i.e. name; address; phone; business description) into the directory database for searching. There is no phone operator to assist buyers with City Directory. Buyers/users will select, at random, from a list of businesses in the category the user has chosen to search. City Directory will not quantify any listings or buyers/users. We simply provide a single directory for all businesses to be found easily and without intrusive advertising or opinions about any business. We do not include information about the business. Any information/description is supplied by the business that has listed within the directory and is limited to the number of words in the description. Our listings do not come from nor are networked with any existing database.

4) U.S. Pat. No. 6,208,998 B1

Description:

A method and system for altering content of a record in a database over Internet is provided. The method includes receiving a request generated over the Internet by a requester that requests records in the database. Searching the records for a requested record corresponding to the request and, upon finding the requested record, displaying the requested record content and an alter record indicator. The requester generating an alter record request over the Internet by selecting the alter record indicator and providing a verification address. If the alter record request contains the verification address, displaying a confirmation message to the requester. The confirmation message comprising a reply address and a reference code. The requester sending an alter record message containing the reference code to the reply address. After receipt of the alter record message at the reply address, determining whether the alter record message contains the reference code. If the later record message contains the reference code, updating the requested record according to the alter record message.

My invention overcomes the deficiencies of the previous invention as my directory does not include the information searched by the users Internet Service Provider (ISP) or directory service mail server.

City Directory has nothing to do with accessing any ISP or directory service. City Directory does not contain any records about a business other than what has been included in the single page devoted to that business (i.e. name; address; phone). City Directory does not alter any information the business has provided for its listing.

City Directory searches only the businesses that have included their information in our directory. Results are based upon the search criteria from the user—generally; state, city and category results.

5) U.S. Pat. No. 6,523,012 B1

Description:

A system and method for efficiently searching directory listing information to obtain more relevant results is provided. In a computer system running a computing application, it is advantageous to provide search capabilities, in the form of a search engine, to operators to assist them in their effort of retrieving desired data . . . .

My invention overcomes the deficiencies of the previous invention as my directory does not require software installed on the users computer that interacts with the search engines. City Directory does not use any software that resides on the users computer. City Directory uses “only” the database contained within the City Directory On Line. The information revealed in a search of City Directory will provide “only” the business name, address and phone listed under the related categories (if multiple categories are selected by the business). It's up to the user to select the name of the business found in the category results.

(i.e. A user will search “Washington”, “Bellingham” and then select a category. All businesses that have elected to be associated with that category will appear. The results will only have the business name, address and phone. That business name is linked (if it's a paid listing) to the page inside City Directory for that business. If the business has “not” paid for a listing the information revealed will only be text that is not linked to anything.)

### SUMMARY OF THE INVENTION

In accordance with the present invention, there is provided an Internet directory specifically aimed at local searching as opposed to Nation wide listings for businesses only that offers a full-page advertisement for paid listings, which is available for that business to edit/alter 24/7. City Directory On Line is optimized for and is already ranking high in the search engines in order to direct the public to the listings.

### BRIEF DESCRIPTION OF THE DRAWINGS

### DESCRIPTION OF THE PREFERRED EMBODIMENT

1. At the “home” page of www.CityDirectoryOnLine.com, the user selects a state, city and category. The user then clicks on the “Search” button conspicuously displayed under the selection boxes. As soon as the “Search” button is clicked the user is taken to the results page. (Searches may be performed from most any page of the site.)

2. At the results page the user reviews the results and makes a selection. If the user wishes to contact a business with a “Free” listing they simply use the information found on this page. If the user wishes to select a business with hyper linked information they are taken to the full-page listing for that one business—step 3.

3. After clicking on one of the search results the user arrives at the full-page advertisement/listing for that business. The listing includes:
Up to 3 images of the business
Business title and address
Map using address in listing
Listing description provided by business
Contact form to send E-mail to business
24/7 access to edit/update all information and/or images

What is claimed is:

1. A computer Internet directory and method of searching for a, business name, category phone or address of an entity comprising:
receiving a request for an address of an entity;
selecting a verified attribute associated with the entity; and
using the verified attribute, searching for potential addresses of the entity.

2. A computer Internet directory and method as in claim 1 wherein the verified attribute is a telephone number of the entity.

3. A computer Internet directory and method as in claim 1 wherein the verified attribute is obtained from a persistent storage, that includes verified information about a plurality of entities.

4. A computer Internet directory and method as in claim 3 wherein the persistent storage includes: City Directory On Line business information database.

6. A computer Internet directory and method as in claim 1 wherein searching for potential name of business, phone category or addresses of the entity further includes:
obtaining search result hits.

7. A computer Internet directory and method as in claim 1 further includes displaying advertisements for only the business found on the full-page devoted to that business along with a business name, map and business description attribute with the entity.
